(19) United States
(12) Patent Application Publication
(10) Pub. No.: US 2012/0083551 A1
(43) Pub. Date: Apr. 5, 2012

(54) MODIFIED EPOXIDE PRIMERS

(75) Inventors: Mark D. Soucek, Akron, OH (US); Cynthia G. Templeman, Ypsilanti, MI (US); Elif Alyamac, Portsmouth, NH (US); Hua Gu, La Mirada, CA (US); Masahiko Ishii, Okazaki City (JP)

(73) Assignees: Toyota Motor Engineering & Manufacturing North America, Inc., Erlanger, KY (US); Toyota Motor Corporation, Toyota (JP); University of Akron, Akron, OH (US)

(21) Appl. No.: 13/020,642

(22) Filed: Feb. 3, 2011

Related U.S. Application Data
(60) Provisional application No. 61/388,665, filed on Oct. 1, 2010.

(51) Int. Cl. C09D 163/00; C08G 63/91; C08G 59/14

(52) U.S. Cl. 523/400; 525/476; 525/523; 525/418

(57) ABSTRACT

Telechelic resins with reactive end groups (e.g., epoxy phosphate and epoxy ester) were synthesized using bisphenol-A (BPA) epoxide. The bisphenol-A based epoxide and the telechelic resins were all modified with tetraethylorthosilicate (TEOS) oligomers to produce epoxide/polysilicate (organic/inorganic) hybrid systems. The modified epoxides were thermally cured with a melamine-formaldehyde resin, cast on steel substrates and salt spray analysis revealed that the inorganically modified epoxides provided improvement over unmodified epoxide resins with respect to both corrosion resistance and adhesion to steel substrates.

### REFERENCE TO RELATED APPLICATION

This application claims priority to U.S. Provisional Patent Application Ser. No. 61/388,665, filed Oct. 1, 2010, the entire content of which is incorporated by reference.

### FIELD OF THE INVENTION

The present invention is related to modified epoxide primers, and in particular, to such primers modified with tetraethylorthosilicate oligomers.

### BACKGROUND OF THE INVENTION

Organic/inorganic hybrid materials have received much attention for more than two decades [1,2], since the hybrids synergistically combine the advantageous properties of both materials. The hybrid materials provide unique properties such as improved physical, mechanical, thermal, gas barrier, and photonic properties [3-7]. A variety of elastomers, thermoplastics, and crosslinked systems have been modified in situ with inorganic materials [8-10]. The hybrid materials have combined the properties of the inorganic materials, i.e. hardness, durability, and thermal stability, and organic polymers, i.e. flexibility and toughness. As a consequence, such hybrids are promising materials for various applications, such as solid state lasers, replacements for silicon dioxide as insulating materials in the microelectronic industry, contact lenses or host materials for chemical sensors [11-14].

Coatings science has also made improvements in corrosion protection, impact, chemical, tamper resistance, antifouling, appearance, flexibility, and impermeability by the application of inorganic/organic hybrid coating systems [15-18]. In the hybrids, the sol-gel technique of alkoxysilanes is one of the useful methods to prepare organic/inorganic hybrid materials, since the reaction can proceed in liquid solution at ambient temperature. The general sol-gel reaction scheme is based on the hydrolysis of various alkoxides to form respective silanols [19]. This is followed by a condensation reaction occurring between silanols or silanols and alkoxides. The organic components of the inorganic-organic hybrids can be, in general, generated either by simultaneous synthesis of two independent (not covalently-bound) polymer networks (organic and inorganic), or by creation of matrices with covalent bonds connecting the organic and inorganic components [20,21]. Organic monomers or polymers modified with alkoxysilane groups are used as coupling agents to provide bonding to the in situ formed inorganic structure. Strong interaction between organic and inorganic phases have been found to improve the mechanical properties of the hybrid [20,22,23].

Silicon sol-gel techniques have been widely used to prevent the corrosion of metals and to improve the coatings adhesion [24-27]. Holmes-Farley and Yanyo [28] used tetraethoxysilane (TEOS) in conjunction with an aminosilane adhesion promoter to prevent corrosion on aluminum substrate. Soucek et al. [29,30] studied polyurea and polyurethane organic/inorganic films using different sol-gel precursors such as organofunctional alkoxysilanes. The polyurethane/polysiloxane was developed to be a “Unicoat” system [31-33]. In this system, polyurethane provides the general mechanical properties as both the primer and topcoat, and polysiloxane functions as an adhesion promoter and corrosion inhibitor. The ceramer films exhibited enhanced adhesion and corrosion resistance properties via a self-assembly phase separation mechanism. The corrosion resistance was comparable to chromate pretreated systems, and thus part of the body of research devoted to chromate replacement. Organic/inorganic hybrid coatings were also reported mixing drying oils with sol-gel precursors, using an approach developed by Soucek and coworkers [34,35]. The resulting hybrid coatings showed improved hardness and adhesion with increasing sol-gel precursor content.

There have been few reports to date on the preparation of epoxide resin/silica hybrids. Several researchers [36-38] investigated epoxide resin-montmorillonite hybrids, using the intercalation process and the well-defined dimensions of the clay layers. Landry et al. [39] prepared a hybrid material from a very high molecular weight epoxide, functionalized with γ-aminopropyltriethoxysilane, and silica. Hussain et al. [40] reported the preparation of a hybrid material based on an epoxy resin/silica system, using tetraglycidyl-meta-xylene-diamine as the resin. In their study, the hybrid was prepared via producing silica filler, using sol-gel method, which was subsequently incorporated into the epoxy resin mixture. The epoxide-silica interpenetrating networks (IPNs) were also investigated by Bauer et al. [41] and modelled by Matejka et al. [42,43]. The hybrid systems composed of organic rubbery network and inorganic silica structure formed by the sol-gel process from tetraethoxysilane.

Epoxides, in particular, bisphenol-A type (BPA) epoxides have been the primer of choice for metal since its introduction into the commercial market place. Epoxide primers have excellent adhesion to metal due to the secondary hydroxyl group in the repeat unit [44]. Epoxides are also noted for hardness, hydrophobicity, and chemical resistance due to the BPA group. The systematic characterization, evaluation and comparison of the corrosion performance and adhesion for low molecular weight epoxide derivatives/tetraethoxysilane oligomer hybrid systems have not yet been reported.

### SUMMARY OF THE INVENTION

Telechelic resins with reactive end groups (epoxy phosphate and epoxy ester) were synthesized using bisphenol-A (BPA) epoxide. The bisphenol-A based epoxide, the epoxy phosphate, and the epoxy ester were all modified with tetraethylorthosilicate (TEOS) oligomers, which were prepared through the hydrolysis and condensation of TEOS monomer with water under acidic condition. The epoxide/polysilicate (organic/inorganic) hybrid systems were characterized systematically, using fourier transform infrared spectroscopy (FTIR); ¹H, ¹³C, ³¹P, and ²⁹Si nuclear magnetic resonance (NMR); and matrix-assisted laser desorption/ionization time of flight mass spectroscopy (MALDI-TOF). The modified epoxides were thermally cured with a melamine-formaldehyde resin, cast on steel substrates. The coating performance of the modified epoxides was evaluated by pencil hardness, crosshatch adhesion, reverse and direct impact resistance, mandrel bending, and pull-off adhesion. Viscoelastic properties of the hybrid systems were also evaluated as a function of polysilicate content. Corrosion performance was evaluated via salt spray (fog) test for 264 hours. Salt spray analysis revealed that inorganically modified epoxides provided improvement over the unmodified epoxide resins with respect to both corrosion resistance and adhesion to steel substrates.

### BRIEF DESCRIPTION OF THE DRAWINGS

FIG. 1 is a schematic illustration of a chemical structure for: a) BPA based epoxide resin; b) epoxy phosphate; and c) epoxy ester;

FIG. 2 is a schematic illustration of the chemical structures shown in FIG. 1 modified with the: a) BPA based epoxide resin; b) epoxy phosphate; and c) epoxy ester, modified with TEOS oligomers;

FIG. 3 is an FTIR spectrum of the bisphenol-A based epoxy phosphate;

FIG. 4 is an FTIR spectra of the bisphenol-A based epoxide and the epoxy ester;

FIG. 5 is a Mass spectrum of the TEOS oligomer modified epoxy phosphate.

FIG. 6 is a schematic representation of a crosslinking reaction between melamine formaldehyde resin and the —OH functionality of the epoxide resin;

FIG. 7 is a graphical illustration of the viscoelastic properties: storage modulus (a) and tan δ (b); as a function of temperature in epoxy/TEOS hybrid coatings for 0% (E0), 2.5% (E2.5), 5% (E5), 7.5% (E7.5) and 10% (E10) TEOS;

FIG. 8 is a graphical illustration of the viscoelastic properties: (a) storage modulus; and (b) tan δ; as a function of temperature in epoxy phosphate/TEOS hybrid coatings for 0% (EP0), 2.5% (EP2.5), 5% (EP5), 7.5% (EP7.5) and 10% (EP10) TEOS;

FIG. 9 is a graphical illustration of the viscoelastic properties: (a) storage modulus; and (b) tan δ; as a function of temperature in epoxy ester/TEOS hybrid coatings for 0% (EE0), 2.5% (EE2.5), 5% (EE5), 7.5% (EE7.5) and 10% (EE10) TEOS;

FIG. 10 is a series of optical images for untreated steel substrates coated with epoxide/TEOS hybrid coatings (E0=0%; E2.5=2.5%, E5=5%, E7.5=7.5% and E10=10% TEOS oligomers) after 96 h and 264 h salt spray exposures;

FIG. 11 is a series of optical images for untreated steel substrates coated with epoxy phosphate/TEOS hybrid coatings (EP0=0%; EP2.5=2.5%, EP5=5%, EP7.5=7.5% and EP10=10% TEOS oligomers) after 96 h and 264 h salt spray exposures;

FIG. 12 is a series of optical images for untreated steel substrates coated with epoxy ester /TEOS hybrid coatings (EE0=0%; EE2.5=2.5%, EE5=5%, EE7.5=7.5% and EE10=10% TEOS oligomers) after 96 h and 264 h salt spray exposures; and

FIG. 13 is schematic illustration of a proposed mechanism for the interaction between hybrid coatings coating according to an embodiment of the present invention and a steel substrate.

### DETAILED DESCRIPTION OF THE INVENTION

The present invention discloses a modified primer composition and a process for making a modified primer composition that provides improved corrosion resistance to a coated substrate. As such, the present invention has utility as a primer and/or base coat layer for a protective and aesthetically pleasing coating.

The modified primer composition can include a telechelic resin and an alkoxide oligomer. The telechelic resin can be an epoxide with reactive end groups and may or may not have at least two phenol functional groups. The epoxide can be bisphenol-A (BPA) epoxide or a cycloaliphatic epoxide such as an acrylic cycloaliphatic epoxide and the like. The reactive end groups can include at least one hydroxide group.

In some instances, the telechelic resin with reactive end groups is an epoxy phosphate, epoxy ester or epoxy molybdate. In addition, the alkoxide oligomer can be a metal alkoxide oligomer or an alkoxysilane oligomer such as tetraethylorthosilicate oligomer (TEOS), tetramethylorthosilicate oligomer (TMOS) and the like.

The modified primer can be used to coat metals and/or alloys, illustratively including uncoated steels, galvanized steels, aluminum alloys and the like. In addition, the modified primer can be used as a base coat for a self-stratifying coating.

In order to better illustrate, but in no way limit the scope of the invention, example modified primer compositions and a process for making modified primer compositions are provided below.

### Materials

Telechelic resins with reactive end groups (epoxy phosphate and epoxy ester) were synthesized using bisphenol-A (BPA) epoxide. The bisphenol-A based epoxide, the epoxy phosphate, and the epoxy ester were all modified with tetraethylorthosilicate (TEOS) oligomers, which were prepared through the hydrolysis and condensation of TEOS monomer with water under acidic condition. The epoxide/polysilicate (organic/inorganic) hybrid systems were characterized systematically, using fourier transform infrared spectroscopy (FTIR); ¹H, ¹³C, ³¹P, and ²⁹Si nuclear magnetic resonance (NMR); and matrix-assisted laser desorption/ionization time of flight mass spectroscopy (MALDI-TOF). The modified epoxides were thermally cured with a melamine-formaldehyde resin, cast on steel substrates. The coating performance of the modified epoxides was evaluated by pencil hardness, crosshatch adhesion, reverse and direct impact resistance, mandrel bending, and pull-off adhesion. Viscoelastic properties of the hybrid systems were also evaluated as a function of polysilicate content. Corrosion performance was evaluated via salt spray (fog) test for 264 hours. Salt spray analysis revealed that inorganically modified epoxides provided improvement over the unmodified epoxide resins with respect to both corrosion resistance and adhesion to steel substrates.

Bisphenol-A (BPA) based liquid epoxide (trade name: DER 317) was obtained from Dow Chemicals. Pamolyn 380 mixture of fatty acids (70 wt. % conjugated linoleic acid, the remaining portion is oleic and nonconjugated linoleic acid) was obtained from Eastman Chemical Company. Tetraethoxysilane (TEOS), phosphoric acid (ACS reagent, >99.0%), hydrochloric acid (37 wt. % in water), ethanol, p-xylene (puriss. p.a., ≧99.0%), diethylene glycol butyl ether (puriss. p.a., ≧99.2%), and dibutyltin oxide were purchased from Aldrich Chemical Company. Methanol-etherified melamine formaldehyde resin (trade name: Luwipal 072) was obtained from BASF Corporation. Plain steel (0.020 inch thick) substrates were purchased from The Q-Panel Company. All of the materials were used as received. The chemical structures of materials are shown in Table 1.

TABLE 1
Chemicals nomenclature and structure

| Chemicals | Nomenclature | Structure |
|---|---|---|
| Sol-gel Precursor | Tetraethoxysilane (TEOS) | 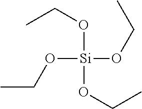 |
| DER317 Epoxide Resin | Bisphenol-A Based Epoxide | 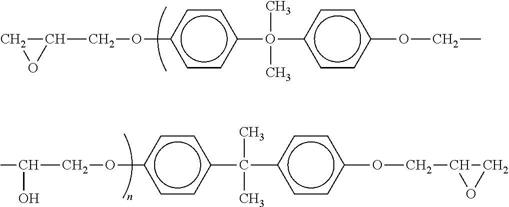 |
| Pamolyn 380 Mixture of Fatty Acids | Conjugated Linoleic Acid (70 wt. %) | 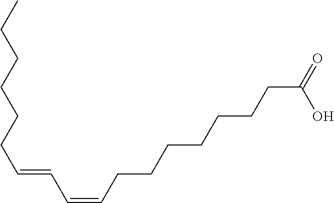 |
| Solvent | p-Xylene | 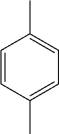 |
| Solvent | Ethanol | 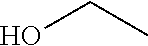 |
| Solvent | Diethylene Glycol Butyl Ether | 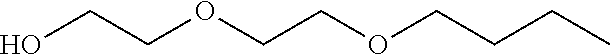 |
| Catalyst | Dibutyltin Oxide | 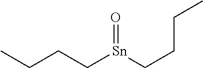 |
| Catalyst | Hydrochloric Acid | H—Cl |
| Acid | Phosphoric Acid | 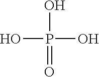 |

### Epoxide Equivalent Weight Determination

Epoxide equivalent weight was determined according to ASTM D1652-97. Liquid epoxide resin (DER 317, 0.3 g) was put into a 250-mL Erlenmeyer flask. Methylene chloride (30 mL) was also added to the flask to dissolve the resin. Tetraethyl ammonium bromide (3.75 g) was dissolved in glacial acetic acid (15 mL) and the solution was mixed with epoxide using a magnetic stirrer. A few drops of phenolphthalein solution (0.1 wt. % in methanol) were added as an indicator. The titration was performed with a perchloric acid solution (0.1 N in glacial acetic acid). Epoxide equivalent weight was calculated using the equation below:

$$E E W = \frac{W \times 1000}{V \times N} \qquad ( 1 )$$

where W is the weight of the epoxide (g), V is the amount of 0.1 N perchloric acid solution used for sample titration (mL), and N is the normality of the perchloric acid solution. The equivalent weight of epoxide was calculated as 192 g/eq. After EEW determination, n was calculated as 0.155 based on the chemical structure of liquid epoxide resin depicted in Table 1.

### Synthesis of BPA Based Epoxy Phosphate (EP)

Based on epoxide resin, 1 wt. % phosphoric acid (1 g, 0.0102 mol) was dissolved in diethylene glycol butyl ether (9.67 g, 0.0596 mol, 10 mL). The solution was added dropwise to a round-bottom four-neck flask (500 mL) containing epoxide resin (DER 317, 100 g) while the mixture was mechanically stirred. The reaction was carried out at 150° C. for 1 h. 2 wt. % (based on epoxy resin) distilled water (2.00 g, 0.111 mol) was then added to the hot mixture, and stirred at 150° C. for 2 h. The number average molecular weight (Mₙ) obtained by gel permeation chromatography (GPC) was 543 with a polydispersity index of 1.48. ³¹P NMR shows a singlet at 108.2 ppm, assigned to phosphorous in C—O—P group. ¹H and ¹³C NMR resonance assignments of the epoxy phosphate are given in Table 2.

TABLE 2
¹H and ¹³C NMR resonance assignments of epoxy phosphate

| | ¹H NMR | | ¹³C MR |
|---|---|---|---|
| Structural Group | (ppm) | Structural Group | (ppm) |
| P—OH | 1.32-1.38 | — | — |
| C(CH₃)₂^{‡} | 2.07 | C(CH₃)₂ | 30.70 |
| CH₂—O—CH^{§} | 3.16-3.19 | CH₂—O—CH | 43.93 |
| CH₂—O—CH^{§} | 3.31-3.34 | CH₂—O—CH | 49.71 |
| CH—CH₂—O | 3.50-4.60 | CH—CH₂—O* | 68.53 |
| CH—OH | 3.50-4.60 | CH—OH* | 68.53 |
| CH(OH)—CH₂—O | 3.50-4.60 | CH(OH)—CH₂—O* | 68.53 |
| CH^{¢} | 7.24 and | CH^{†} | 113.70^{a} and |
| | 7.56-7.59 | | 127.40^{b} |
| — | — | C—C(CH₃)₂^{¤} | 143.1 |
| — | — | C—O—CH₂^{¤} | 156.0 |

^{‡}Pendant methyl groups in the bisphenol-A based epoxide network.
^{§}1, 2-oxirane ring.
^{¢}Protons in the benzene ring.
*Peak originating from carbon atoms directly bonded to an oxygen atom.
^{†}Carbons in the benzene ring are attached to a carbon atom which is directly bonded to either an oxygen atom^{a} or a carbon atom^{b}.
^{¤}Aromatic carbon.

### Fatty Acid Equivalent Weight Determination

Fatty acid (Pamolyn 380, 2 g) was dissolved in high purity grade acetone (39.25 g, 50 mL) in a 250-mL Erlenmeyer flask. 3-4 drops of phenolphthalein solution (0.1 wt. % in methanol) were added as an indicator. The solution was then titrated with a KOH solution (0.1 N in methanol). Fatty acid equivalent weight was determined by the equation below:

$${E}_{FA} = \frac{W \times 1000}{( B - V ) \times N} \qquad ( 2 )$$

where W is the weight of the fatty acid (g), B is the amount of 0.1 N KOH solution used for blank test (mL), V is the amount of 0.1 N KOH solution used for sample titration (mL), and N is the normality of the KOH solution. The equivalent weight of fatty acid was determined as 321 g/eq.

### Synthesis of BPA Based Epoxy Ester (EE)

Esterification reaction was conducted in a 500-mL, round bottom, four-necked flask placed in a heating mantle which was connected to a temperature controller and the reaction flask was equipped with a thermometer, a mechanical stirrer, a nitrogen gas inlet, a Dean-Stark trap, and a reflux condenser. The liquid epoxide resin (DER 317, Mₙ=356 with a polydispersity index of 1.03, E_{E}=192 g/eq.) was reacted with fatty acid (Pamolyn 380, E_{FA}=321 g/eq.) based on 1:1 equivalence ratio of epoxide group to fatty acid group. Accordingly, the epoxide resin (100 g.), fatty acid (167 g.), xylene (10.68 g, 0.1008 mol, 4 wt. % based on total amount of epoxide and fatty acid) and catalyst, dibutyltin oxide (0.8010 g, 0.0032 mol, 0.3 wt. % based on total amount of epoxide and fatty acid) were all charged to the reaction flask. The reaction mixture was heated slowly to 210° C. and kept at that temperature for 6 h until the acid value is below 5 mg KOH/g. (ASTM D1639-90). The number average molecular weight (Mₙ) was measured as 1528 with a polydispersity index of 1.42. ¹H and ¹³C NMR resonance assignments of the epoxy ester are given in Table 3.

TABLE 3
¹H and ¹³C NMR resonance assignments of epoxy ester

| Structural Group | ¹H NMR (ppm) | Structural Group | ¹³C NMR (ppm) |
|---|---|---|---|
| CH₃^{¥} | 0.8-1.0 | CH₃ | 14.1 |
| CH₂^{¥} | 1.4 | CH₂ | 23-35 |
| C(CH₃)₂^{‡} | 1.7-1.8 | C(CH₃)₂ | 31 |
| OC(═O)CH₂CH₂ | 1.7-1.8 | C(CH₃)₂ | 42.4 |
| OC(═O)CH₂CH₂^{α} | 2.1 | OC(═O)CH₂CH₂ | 33.9 |
| CH₂—O—CH^{§} | 2.5-2.8 | CH₂—O—CH | 44.2 |
| CH₂—O—CH^{§} | 3.2 | CH₂—O—CH | 50.0 |
| CH(—OH)CH₂OC(═O) | 4.4-4.9 | CH(—OH)CH₂OC(═O)* | 67.1-71.3 |
| CH(—OH)CH₂OC(═O) | 4.4-4.9 | CH(—OH)CH₂OC(═O)* | 67.1-71.3 |
| OCH₂CH(—OC(═O)) | 4.4-4.9 | OCH₂CH(—OC(═O))* | 67.1-71.3 |
| OCH₂CH(—OC(═O) | 4.4-4.9 | OCH₂CH(—OC(═O)* | 67.1-71.3 |
| CH═CHCH₂CH═CHCH₂^{Δ} | 5.4-6.2 | CH═CHCH₂CH═CHCH₂ | 127.0-132.2 |
| CH^{¢} | 6.7-7.6 | CH^{†} | 114.5^{a} and 128.3^{b} |
| — | — | C—C(CH₃)₂^{¤} | 140.7 |
| — | — | C—O—CH₂^{¤} | 155.8 |
| — | — | C═O | 173.6 |

^{¥}Methyl or methylene or methyne groups in the ester chain.
^{‡}Pendant methyl groups in the bisphenol A based epoxide network.
^{α}Protons of carbon atom which is attached to carboxyl group in the ester chain.
^{§}1,2-oxirane ring.
^{Δ}Protons of methylidyne/methyne groups in the ester chain.
^{¢}Protons in the benzene rings.
*Peak originating from carbon atoms directly bonded to an oxygen atom.
^{†}Carbons in the benzene ring are attached to a carbon atom which is directly bonded to either an oxygen atom^{a} or a carbon atom^{b}.
^{¤}Aromatic carbon.

### Preparation of TEOS Oligomers and TEOS Oligomer Modified Epoxides

Tetraethylorthosilicate (TEOS, 100 g, 0.48 mol) was dissolved in ethanol (88.32 g, 1.92 mol) in a round-bottom flask (250 mL); distilled water (8.64 g, 0.48 mol) was then added into the mixture. After the water dissolved, hydrochloric acid (0.175 g, 0.0048 mol) was added dropwise, while the mixture was mechanically stirred. The reaction was carried out at ambient temperature for 96 h. The unreacted residuals in the mixture were removed using a rotary evaporator at 50° C. to afford TEOS oligomers (77.23% yield based on TEOS). The product was characterized by ¹H and ²⁹Si NMR, FTIR, and ESI-MS. Later, commercial epoxide, synthesized phosphated epoxy and synthesized epoxy ester were all mixed with TEOS oligomer solution in different weight ratios (2.5 wt. %, 5 wt. %, 7.5 wt. % and 10 wt. %; based on total solution) and stirred under acidic condition at 40° C. for 72 h to produce the corresponding hybrid systems prior to being mixed with the crosslinking agent. ¹H and ¹³C NMR resonance assignments of TEOS oligomer modified epoxy phosphate and epoxy ester are given in Table 4.

TABLE 4
¹H and ¹³C NMR resonance assignments of inorganic modified epoxy derivatives;
epoxy ester (EE) and epoxy phosphate (EP)

| | ¹H NMR | | | ¹³C NMR | |
|---|---|---|---|---|---|
| | (ppm) | | | (ppm) | |
| Structural Group | EE | EP | Structural Group | EE | EP |
| CH₃^{¥} | 0.9-1.1 | — | CH₃ | 14.0-14.2 | — |
| SiOCH₂CH₃ | 0.9-1.1 | 1.1 | SiOCH₂CH₃ | 18.3-18.6 | 19.1 |
| CH₂^{¥} | 1.3-1.4 | — | CH₂ | 22.3-34.1 | — |
| POH | — | 1.3-1.4 | C(CH₃)₂ | 41.7 | 41.5 |
| C(CH₃)₂^{‡} | 1.7-1.8 | 1.7-1.8 | C(CH₃)₂ | 31.1 | 30.9 |
| OC(=O)CH₂CH₂ | 1.7-1.8 | — | OC(═O)CH₂CH₂ | 24.9 | — |
| OC(=O)CH₂CH₂^{α} | 2.2-2.3 | — | OC(═O)CH₂CH₂ | 25.7 | — |
| CH₂—O—CH^{§} | 2.4-2.5 | 2.8-2.9 | CH₂—O—CH | 44.7 | 44.5 |
| CH₂—O—CH^{§} | 2.9-3.1 | 3.0-3.1 | CH₂—O—CH | 50.3 | 50.1 |
| SiOCH₂CH₃ | 3.8-4.6 | 3.5-4.4 | SiOCH₂CH₃ | 58.2-61.6 | 61.5 |
| OCH₂CH(—OSi)CH₂) | 3.8-4.6 | — | OCH₂CH(—OSi)CH₂) | 62.5-63.6 | 63.6 |
| CH—CH₂—O | — | 3.5-4.4 | CH—CH₂—O | 65.2-66.2 | 68.6 |
| CH₂(O(C=O))CH(—OSi) | 3.8-4.6 | — | CH₂(O(C═O))CH(—OSi) | 68.5-68.7 | — |
| CH₂—O—P | — | 3.5-4.4 | CH₂—O—P | — | 70.4 |
| CH₂(O(C=O))CH(—OSi) | 3.8-4.6 | — | CH₂(O(C═O))CH(—OSi) | 70.5 | — |
| OCH₂CH(—OSi)CH₂) | 3.8-4.6 | 3.5-4.4 | OCH₂CH(—OSi)CH₂) | 72.7 | 725 |
| CH^{¢} | 6.9-7.4 | 6.9-7.3 | CH^{†} | 113.9^{a} | 113.9^{a} |
| | | | | 127.8^{b} | 127.6^{b} |
| — | — | — | C—C(CH₃)₂^{¤} | 143.6 | 143.4 |
| — | — | — | C—O—CH₂^{¤} | 156.2 | 156.2 |
| — | — | — | C═O | 173.5 | — |

^{¥}Methyl or methylene or methyne groups in the ester chain.
^{‡}Pendant methyl groups in the bisphenol A based epoxide network.
^{α}Protons of carbon atom which is attached to carboxyl group in the ester chain.
^{§}1,2-oxirane ring.
^{Δ}Protons of methylidyne/methyne groups in the ester chain.
^{¢}Protons in the benzene rings.
*Peak originating from carbon atoms directly bonded to an oxygen atom.
^{†}Carbons in the benzene ring are attached to a carbon atom which is directly bonded to either an oxygen n atom^{a} or a carbon atom^{b}.
^{¤}Aromatic carbon.

### Film Preparation and Coating Tests

Film formation was performed by crosslinking the epoxy derivatives with melamine formaldehyde (MF) resin, based on 2:1 equivalence ratio of methoxy groups in MF resin to hydroxy groups in the epoxide. Equivalent weight of MF resin was taken as 80 g/eq, resulting from the presence of dimers, trimers, and higher oligomers [45]. As a strong acid catalyst, p-toluenesulfonic acid monohydrate, 1 wt. % of the MF resin was added to the formulation. The mixtures were stirred for 1 h; later, thin films were cast on steel panels by a draw-down bar with a wet thickness of 125 pm. The wet films were placed in a dust free dry environment at room temperature for 24 h, and were thermally cured at 120° C. for 1 h. The films were used for salt spray (fog) test (ASTM B117) and for coating tests such as pencil hardness (ASTM D3363), cross-hatch adhesion (ASTM D3359), pull-off adhesion (ASTM D4541), impact resistance (ASTM D2794), mandrel bend test (ASTM D522-93), and solvent (MEK) resistance (ASTM D4752). Dry film thickness was typically 50-80 μm. All films were kept for 7 days before testing.

The nomenclature developed to represent the hybrid systems in this study, is focused on the type of the epoxide and the concentration of TEOS in the composition. The designation consists of a term and a number. The first term, “E”, “EP”, or “EE”, defines epoxide, epoxide phosphate, or epoxide ester, respectively. The second term (0, 2.5, 5, 7.5, or 10) designates the alkoxysilane present in the coating. The number quantifies the weight fraction of TEOS relative to the total composition.

### Instruments

Fourier transform infrared (FTIR) spectroscopy was performed with 32 scans in 4000-400 cm⁻¹ on a Thermo Scientific Nicolet 380 FTIR with a diamond crystal UATR. ¹H NMR, ¹³C NMR and ³¹P NMR spectra were recorded on a Gemini-300 MHz spectrometer (Varian) in chloroform-d as a solvent. ²⁹Si-NMR spectra were recorded on a Gemini-400 MHz spectrometer (Varian) in chloroform-d as a solvent. Chemical shifts in ²⁹Si-NMR spectra were determined relative to tetramethylsilane (TMS) reference.

Gel permeation chromatography was performed using a Waters Breeze GPC system consisting of an isocratic HPLC pump, a refractive index detector and a column set consisting of three styragel HR series columns; HR1, HR2, and HR3. Polystyrene (PS) standards were used to calibrate the system. The sample was prepared in distilled tetrahydrofuran (THF) to obtain a 1% (v/v) concentration. Solutions were filtered on 0.45 pm membrane syringe filters and 200 μL was injected into the chromatograph at room temperature with an eluent flow rate of 1.0 mL .min⁻¹.

Mass spectral experiments were performed to assist in determining the chemical structure of copolymers, using a Bruker REFLEX-III time-of-flight matrix-assisted laser desorption ionization mass spectrometer (Bruker Daltonics, Billerica, Mass.) equipped with an LSI model VSL-337ND pulsed nitrogen laser (337 nm, 3 nm pulse width), a two-stage gridless reflector and a single stage pulsed ion extraction source. Separate THF (anhydrous, ≧99.9; Aldrich) solutions of dithranol matrix (20 mg/mL) (>97%; Alfa Aesar), sodium trifluoroacetate (10 mg/mL) (>98%; Aldrich) and copolymer (10 mg/mL) were mixed in a ratio of matrix:cationizing salt:copolymer (10:1:2), and 0.5 μL of the resulting mixture was introduced onto the MALDI target plate. The spectra were obtained in the reflectron mode. The attenuation of the nitrogen laser was adjusted to minimize unwanted copolymer fragmentation and to maximize the sensitivity. The calibration of mass scale was carried out externally using poly(methyl methacrylate) standard (Fluka) with a similar molecular weight as the sample.

The viscoelastic properties were measured on a dynamic mechanical thermal analyzer (Perkin Elmer Instruments, Pyris Diamond DMTA), with a frequency of 1 Hz. in tensile mode, and a heating rate of 3° C./min over a range of −50 to 200° C. N₂ flow rate set to 40 psi was circulated in the DMTA furnace during the measurements. The gap distance was set at 2 mm for rectangular test specimens (length 15 mm, width 8-10 mm and thickness 0.05-0.08 mm). Reproducibility of the DMTA data was verified by scanning over the useful temperature range multiple times.

Pull-off adhesion testing on the coatings was carried out using Elcometer 106 adhesion tester. Three aluminum pull stubs (dollies) were glued to each test panel using a commercial two-part epoxy adhesive. The adhesive was cured for 24 h prior to testing. The tester applied a true axial tensile stress to pull the stub off and the bond strength between the coating and the test surface was quantitatively measured. Average values of bond strengths obtained from three dollies were reported in lb_{f}/in².

Salt spray testing [46] was conducted according to ASTM B117. Coated steel panels were scribed through the coating in a standardized fashion exposing bare substrate and suspended in a salt spray chamber where the panels were exposed to a mist of 5% NaCl solution sprayed by atomizer with a nozzle pressure of 10-12 psi. During the test, the chamber was sealed air tight. The temperature and relative humidity inside the chamber were maintained at 35±2° C. and 99±1%, throughout the test period of 264 h. The condition of the coated panels was closely examined periodically for any surface change by visual inspection. The non-scribed areas were examined for blistering, and the scribe was observed to see how far from the scribe mark the coating was undercut or lost adhesion. The digital images of the coated panels were taken at 96 and 264 h intervals.

### Results

Commercially obtained BPA based epoxide was chemically modified by three different chemical groups; fatty acid, phosphoric acid, and TEOS oligomer. Tetraethylorthosilicate (TEOS) oligomers were prepared through the hydrolysis and condensation of TEOS with water under acidic condition. The organic/inorganic hybrid systems were characterized utilizing FTIR spectroscopy, ¹H, ¹³C, ³¹P and ²⁹Si-NMR and mass spectrometry. The corrosion resistance was examined, exposing the coatings to the salt spray (fog) test. Coating properties were evaluated before the 264 hour salt spray exposure. Viscoelastic properties of the films were investigated as a function of TEOS oligomer content.

### Preparation and Depiction of Organic/Inorganic Hybrid Systems

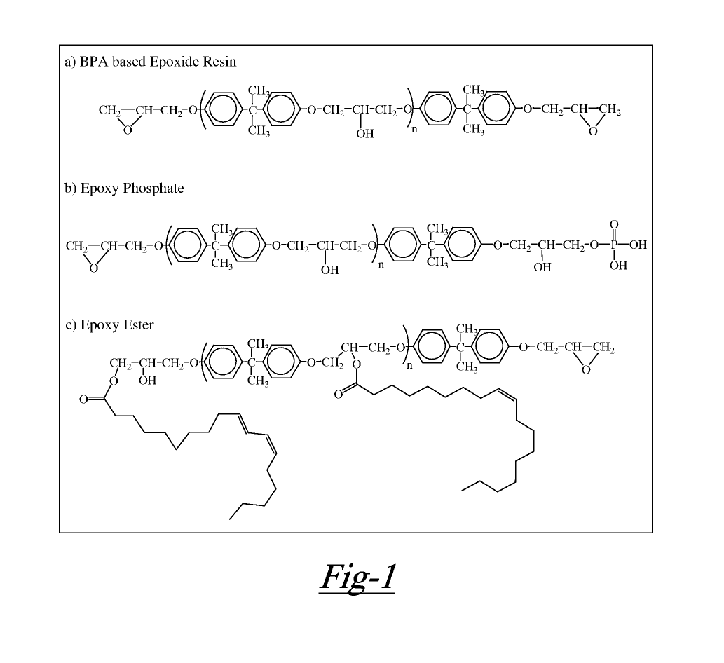

Bisphenol-A based epoxide resin was modified with phosphoric acid and fatty acid to obtain epoxy phosphate and epoxy ester, respectively. The chemical structures of the epoxy derivatives are depicted in FIG. 1.

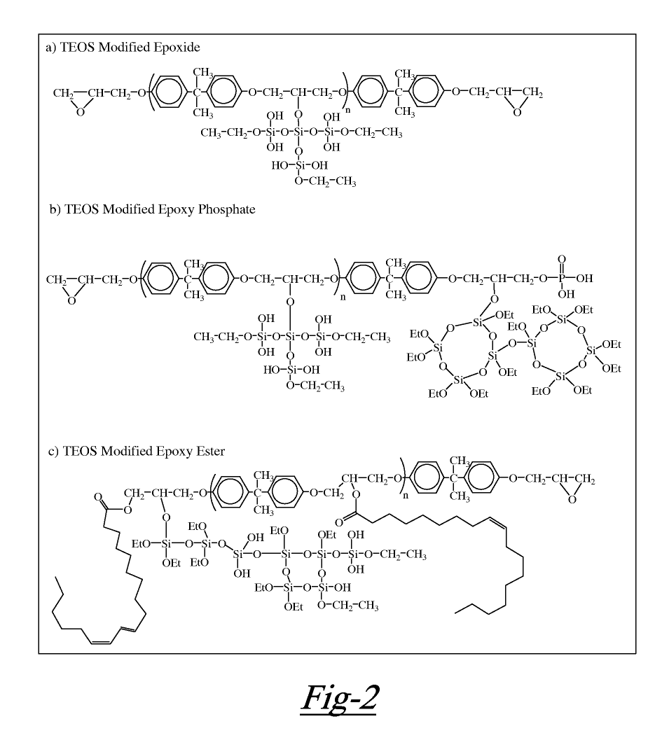

The covalent bonds between inorganic and organic networks may form by the reaction of silanol groups of hydrolyzed tetraethoxysilane clusters and pendant hydroxyl group in the CH₂CH(OH)CH₂O segment of the epoxide. The inorganic structure grafted to epoxy derivatives may exist in different forms as cyclic and/or linear polysilicates. FIG. 2 illustrates the inorganic modified epoxide network structures.

### Structural Characterization of Epoxide Derivatives

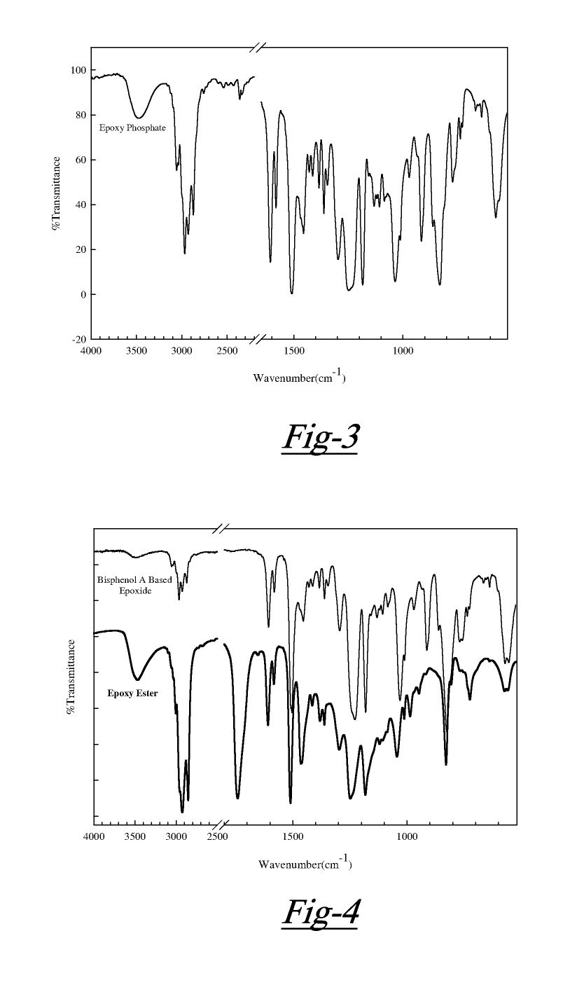

The room temperature FTIR transmission spectrum (FIG. 3) confirms the structure of the bisphenol-A based epoxy phosphate (EP) in all aspects. A very broad absorption peak in the range 3200-3700 cm⁻¹ is attributed to O—H stretching arising from pendant hydroxyl groups in the phosphated epoxide structure. Any C—H stretching bands above 3000 cm⁻¹ result from aromatic C—H stretching. Thus, two closely spaced absorption bands at 3057 and 3036 cm⁻¹ are assigned to the asymmetrical and symmetrical aromatic C—H stretching vibrations in the benzene ring of bisphenol-A and in the oxirane ring (epoxide group). Three distinct bands occurring at 2967, 2928, and 2871 cm⁻¹ are due to asymmetrical and symmetrical C—H stretching modes of several methyl (CH₃) and methylene (CH₂) groups in the structure. The double absorption bands at around 2350 cm⁻¹ is assigned to P—OH stretching vibrations [47]. Weak combination and overtone bands appear in the 1650-2100 cm⁻¹ region (not shown, used an axis break in FIG. 3).

Three strong bands at 1610, 1580, and 1506 cm⁻¹ can be attributed to the aromatic C═C and C—C stretchings of benzene rings in the structure. The absorption bands at 1454 and 1362 cm⁻¹ results from out-of-phase (asymmetrical) and in-phase (symmetrical) bending vibrations of C—H bonds in methyl (CH₃) groups, respectively. The absorption band at 1383 cm⁻¹ is attributed to C—H scissoring vibration of methylene (CH₂) groups. The intensity of the band, arising from the symmetrical bending of the methyl C—H bonds, is greater than that for the asymmetrical methyl bending vibration or the methylene scissoring vibration. Methylene twisting and wagging vibrations are observed in the 1350-1150 cm⁻¹ region. A strong band in the 1260-1200 cm⁻¹ region is the asymmetrical C—O—C stretching vibration in the 1,2-oxirane ring or benzene ring, and the P═O stretching of the phosphate units. A shoulder at 1160 cm⁻¹ is assigned to the vibration modes of P—O bonds [48].

The band at 1035 cm⁻¹ is ascribed to the symmetrical C—O—C stretching vibrations in the epoxy ring and benzene rings. Two distinct bands occurring at 971 and 914 cm⁻¹ are due to out-of-plane C—H bending (twisting) vibrations of methyl and methylene groups in the structure. On the other hand, aromatic out-of-plane C—H bending vibrations in the structure appear at 831 and 775 cm⁻¹. As a result, the modification of BPA based epoxide with phosphoric acid produced small variations, raising slightly the intensity and/or width of different bands related to the phosphorous atom.

FIG. 4 shows the FTIR spectra of bisphenol-A based epoxide resin and synthesized epoxy ester. The O—H stretching band in the range 3200-3600 cm⁻¹ is much broader and sharper in the infrared spectrum of the epoxy ester than the corresponding band observed in the spectrum of the epoxide. The increase in intensity and width results from the higher hydroxyl functionality in the epoxy ester structure. Two absorption bands at 3047 and 3029 cm⁻¹ in the epoxide are assigned to the aromatic C—H stretching vibrations. However, only one absorption band at around 3010 cm⁻¹ appears in the spectrum of the epoxy ester, due to the fact that 1,2-oxirane ring opens up to react with fatty acid during esterification reaction. This may cause the epoxy ester to lose the intensity of ring stretching vibrations. The C—H stretching modes of methyl (CH₃) and methylene (CH₂) groups appear as three distinct bands occurring at 2970, 2921, and 2867 cm⁻¹ in the infrared spectrum of bisphenol-A based epoxide. Whereas, the epoxy ester shows two absorption bands in the same region, occurring at 2918 and 2852 cm⁻¹. In FIG. 4, an axis break is used in the x-axis of the spectrum in order to avoid the large empty wavenumber region between 2500 and 1800 cm⁻¹ and to enlarge the low wavenumber region between 1800 and 500 cm⁻¹.

The strong C═O stretching absorption band has a relatively constant position and high intensity at 1737 cm⁻¹, easily recognized in the spectrum of the epoxy ester. Three bands attributed to the aromatic C═C and C—C stretches are observed at 1608, 1581, and 1508 cm⁻¹ for the epoxy ester. The position of these stretching frequencies remains nearly constant for the epoxy resin, occurring at 1604, 1579, and 1504 cm⁻¹. The absorptions at 1460, 1377, and 1359 cm⁻¹ in the epoxy ester, and at 1452, 1382, and 1361 cm⁻¹ in the epoxide resin, result from asymmetrical vibration of C—H bonds in methyl groups, C—H scissoring vibration of methylene groups, and symmetrical vibration of C—H bonds of methyl groups, respectively.

A strong band resulting from the methylene rocking vibration, in which all of the methylene groups in the epoxy ester structure rock in phase, appears at 723 cm⁻¹ as a singlet. The symmetrical stretching of the epoxy ring occurs near 1250 cm⁻¹. Another band appears at 825 cm⁻¹ attributed to asymmetrical epoxy ring stretching in which the C—C bond is stretching during contraction of the C—O bond [49]. The third band related to the epoxy ring only appears in the spectrum of the epoxide resin at around 750 cm⁻¹.

In the low wavenumber region (600-1500 cm⁻¹) of FTIR spectra of TEOS oligomer modified epoxy derivatives, the intensity of the absorption band at 1000-1110 cm⁻¹ increases due to the Si—O—C (aliphatic) and Si—O—Si stretches [50]. Two strong absorption bands appear at 1107 and 1080 cm⁻¹ in the FTIR spectrum of inorganic modified phosphated epoxide; likewise, two closely spaced absorption bands occurring at 1099 and 1081 cm⁻¹ are observed in the infrared spectrum of inorganic modified epoxy ester. In addition, the O—H stretching vibrations of the Si—OH group absorb in the region 3700-3200 cm⁻¹. The absorption characteristics in that region depend on the degree of hydrogen bonding. Therefore, the intensity and width of the absorption band at around 3500 cm⁻¹ significantly increases after the epoxy derivatives were modified with TEOS oligomer. As previously reported by Soucek et al. [29], spectroscopic characterization of TEOS oligomers were performed using ¹H NMR, ²⁹Si NMR and ESI-MS.

The chemical shifts in the ¹H and ¹³C NMR (CDCl₃) spectra of TEOS oligomer modified epoxy phosphate are summarized in Table 4. ²⁹Si NMR shows a singlet at δ −81.6 ppm, a doublet at −88.6 ppm assigned to Si—O—C (aliphatic) group. The resonance difference may be contributed by the substitution of adjacent silicon atoms. Two singlets at δ −91.2 ppm and -96.0 ppm also appear in the spectrum, attributed to Si—O—Si bonds in the linear or cyclic polysilicates attached to the epoxy phosphate.

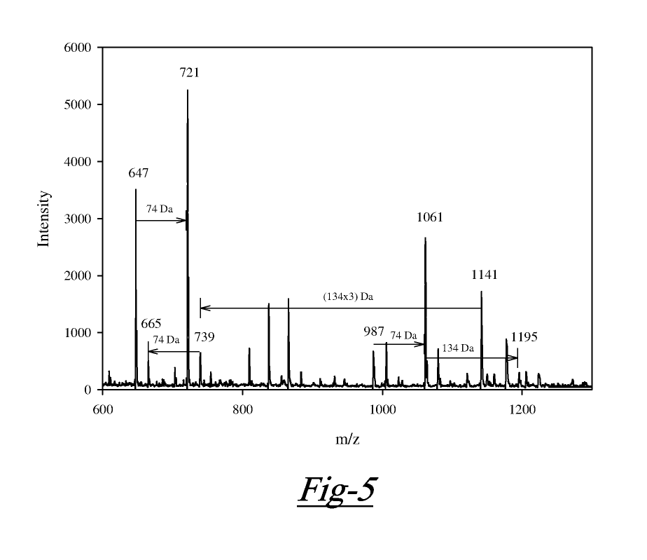

TEOS oligomer modified epoxy phosphate was further analyzed by MALDI-TOF spectrometry, shown in FIG. 5. The observed ions result from the sodium attachment to the species present. For example, the structure corresponding to 1141 Da results from sodium (23 Da) cationization of the cyclic Si₃O₃(OEt)₆ grafted epoxy phosphate. The cyclic Si₃O₃(OEt)₆ ([M]=134n) weighs 402 Da and the inorganically modified epoxy phosphate loses the cyclic trisilicate unit from m/z=1141 to m/z=739. Another distribution corresponding to the modification with linear trisilicate ([M]=74+134n) also appears in the spectrum exhibiting a peak at 665 Da. The species associated with the 1195 Da ion and 1061 Da are interrelated with each other by monocyclic structure, SiO(OEt)₂ (134 Da) unit. On the other hand, the peak at 987 Da is interrelated with the species observed at 1195 Da by the addition of linear Si(OEt)₄ silicate (208 Da).

### Preparation of Thermosetting Epoxy Derivatives

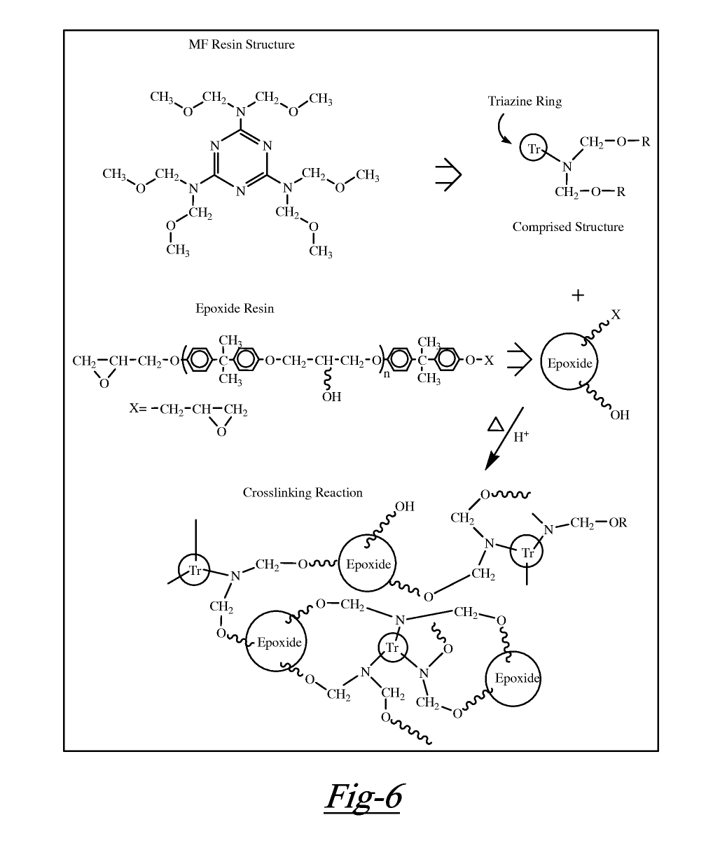

The major crosslinking reaction between the unmodified epoxy resin and the melamine formaldehyde resin is depicted in FIG. 6, showing how the hydroxyl groups in the epoxide repeat unit react with the melamines. After the unmodified and chemically modified epoxy derivatives were all crosslinked with the curing agent; general coatings tests, as well as dynamic mechanical thermal properties, and corrosion resistance were evaluated.

### Viscoelastic Properties

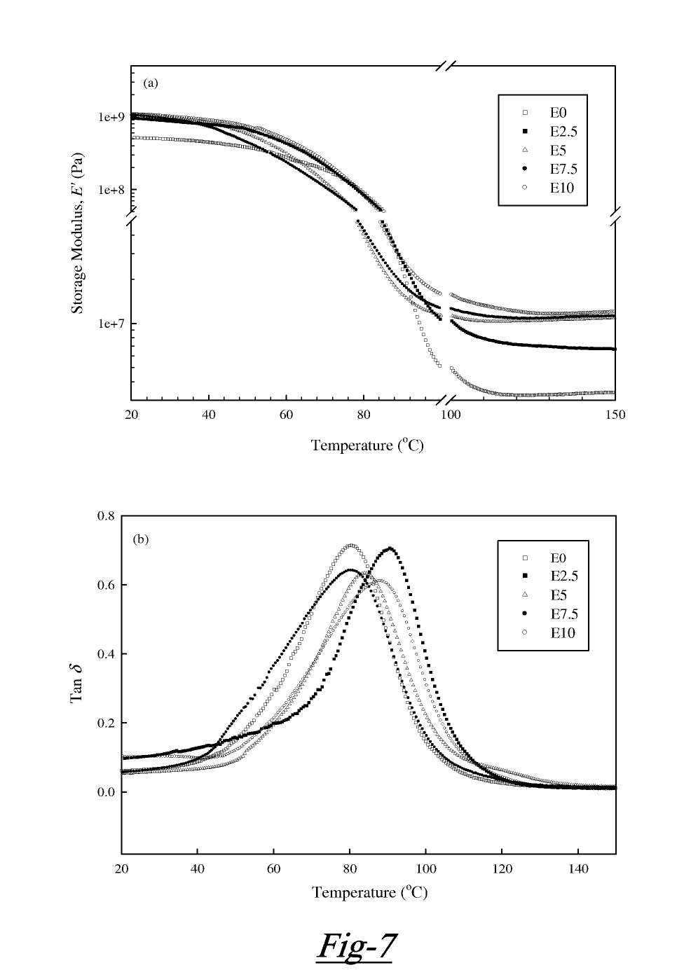

The viscoelastic properties of the hybrid networks were investigated using dynamic mechanical thermal analyzer (DMTA). FIGS. 7a and 7b show the storage modulus and loss factor tan δ of epoxy (E) hybrid networks as a function of temperature, respectively. FIG. 7a is referred to as a semi-logarithmic graph. As the storage modulus data span several orders of magnitude, the distribution of values is more clearly discerned by replacing the linear y scale with a logarithmic y scale in FIG. 7a. In order to enlarge the rubbery plateau of the graph, an axis break is positioned along both axes without omitting any data points. The most striking drop in the tan δ maximum is observed in the epoxide containing 10% TEOS, E10, while the epoxide with 2.5% TEOS, E2.5, shows only a mild lowering. The storage modulus (FIG. 7a) decreases slightly until the film reaches the temperature of 50° C. and decreases significantly between 50 and 110° C. Above 110° C., the storage modulus shows the minimum value for all the epoxy hybrid films. The height of the tan δ peak decreases and the peak broadens as extent of cure increases.

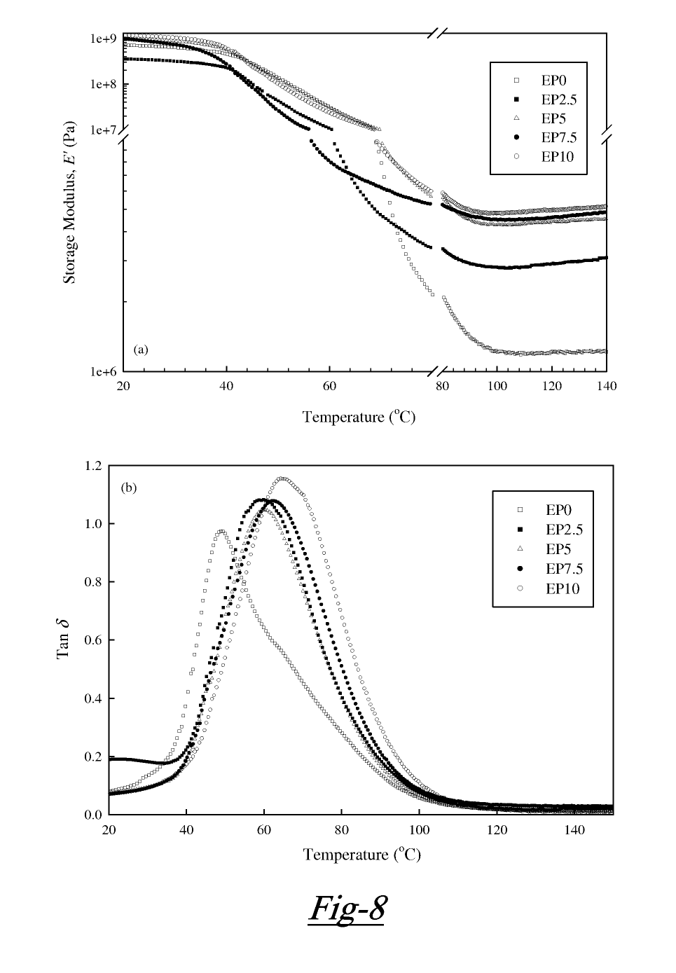

The storage modulus and loss factor tan δ of epoxy phosphate-TEOS oligomer hybrid networks are shown in FIGS. 8a and 8b, respectively. In FIG. 8a, the storage modulus (E′) of epoxy phosphate (EP) hybrid films show a decreasing trend as well, until the temperature reaches 40° C. The value of E′ diminishes drastically between the temperatures 40 and 90° C., and shows the minimum values at temperatures very close to or above 90° C. for phosphated epoxy hybrid networks.

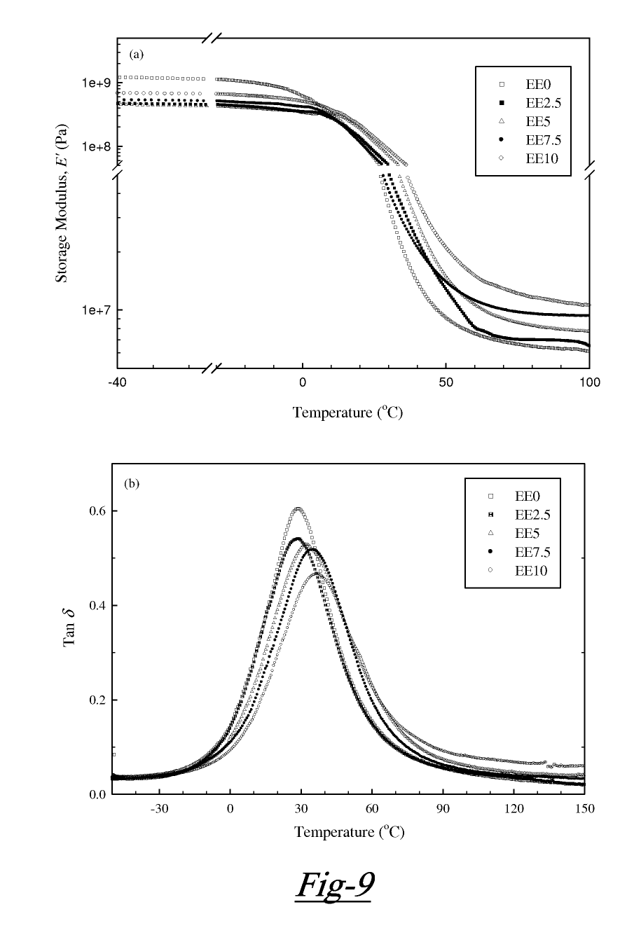

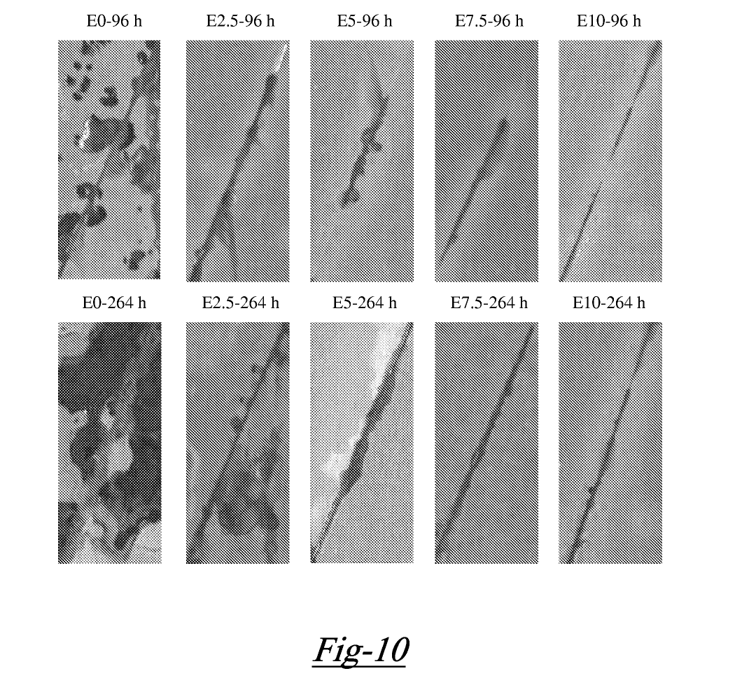

In FIGS. 9a and 9b, the storage modulus (E′) and loss factor tan δ of epoxy ester (EE)/TEOS hybrid systems are shown. In FIG. 9a, the storage modulus (E′) exhibits a slightly decreasing trend until temperature reaches 0° C. Between 0° C. and 60° C., E′ decreases dramatically for epoxy ester (EE)/TEOS oligomer hybrid films. The increase in the storage modulus of the epoxy ester hybrid networks is accompanied by the changes in the loss factor tan δ. The α-transition of tan δ located at about 29° C., corresponds to the glass transition of the neat epoxy ester network, decreases and broadens in the epoxy ester-TEOS oligomer hybrids which is typical of most composite systems [51].

The decrease in the loss maximum height shown in FIG. 9b is directly proportional to the TEOS concentration. Glass transition temperatures of the cured films are also increasing with increasing TEOS content in the hybrid films. None of the hybrid systems display a new damping peak at higher temperatures, which gives evidence of the no macrophase separation in the epoxy derivatives-TEOS hybrid systems. In other words, it promotes a homogenous system with no major separation or clustering of inorganic regions within the film.

FIGS. 8a and 9a are also referred to as semi-logarithmic. No data point was avoided in both graphs and axis breaks were put in the x-axis and in the y-axis, to be able to observe the difference between the minimum storage moduli of the films for a clear comparison on the graph. The crosslink density of the films was calculated via an equation derived from the theory of rubber elasticity [52]. The viscoelastic properties, minimum storage modulus (E′ₘᵢₙ), crosslink density (νₑ), maximum tan δ, glass transition temperature (T_{g}), and breadth of tan δ transition of the epoxy, the epoxy ester, and the epoxy phosphate hybrid films are summarized in Table 5.

TABLE 5
Viscoelastic properties of the epoxy hybrid coatings

| | | Crosslink | | | Tan δ |
|---|---|---|---|---|---|
| Hybrid | E′ (min) | Density | T_{g} | Max | breadth* |
| Networks | (N/m²) | (mol/m³) | (° C.) | Tan δ | (° C.) |
| E0^{a} | 3.3 × 10⁶ | 336 | 80 | 0.72 | 27 |
| E2.5 | 7.2 × 10⁶ | 737 | 91 | 0.71 | 27 |
| E5 | 10.3 × 10⁶ | 1074 | 84 | 0.63 | 30 |
| E7.5 | 11.1 × 10⁶ | 1160 | 80 | 0.64 | 35 |
| E10 | 11.6 × 10⁶ | 1169 | 88 | 0.61 | 35 |
| EE0 | 6.5 × 10⁶ | 747 | 29 | 0.61 | 33 |
| EE2.5^{b} | 7.0 × 10⁶ | 794 | 29 | 0.54 | 35 |
| EE5 | 8.0 × 10⁶ | 886 | 32 | 0.53 | 37 |
| EE7.5 | 9.4 × 10⁶ | 1056 | 35 | 0.52 | 37 |
| EE10 | 10.8 × 10⁶ | 1180 | 37 | 0.47 | 40 |
| EP0 | 2.6 × 10⁶ | 430 | 56 | 0.75 | 28 |
| EP2.5 | 5.8 × 10⁶ | 642 | 60 | 1.08 | 30 |
| EP5^{c} | 9.0 × 10⁶ | 998 | 60 | 1.05 | 31 |
| EP7.5 | 9.3 × 10⁶ | 1028 | 63 | 1.08 | 35 |
| EP10 | 9.8 × 10⁶ | 1075 | 64 | 1.15 | 36 |

*Width at half heightof tan δ.
^{a}E0 denotes the film formed through the epoxy resin with 0% TEOS oligomer based on the amount of the total solution.
^{b}EE2.5 denotes the film formed through the epoxy ester with 2.5% TEOS oligomer based on the amount of the total solution.
^{c}EP5 denotes the film formed through the epoxy phosphate with 5% TEOS oligomer based on the amount of the total solution.

In epoxide (E) systems, a significant increase of glass transition temperature from 84° C. to 91° C. is observed with 2.5% TEOS oligomer modification of epoxy resin by weight. Loss factor decreases with increasing inorganic content; whereas, the crosslink density increases. As for epoxy ester (EE) series, the highest percentage (10%) of the inorganic content in the hybrid films shows the largest crosslink density, which was calculated as 1180 mol/m³. The decrease in glass transition temperature is also observed in epoxy phosphate (EP) films (T_{g} around 60° C.).

### Coating Properties and Corrosion Performance

Table 6 presents the film properties of different TEOS modified epoxy hybrids cured with MF resin. Most of the coating formulations showed the same pencil hardness (5H) and cross-hatch adhesion (5B) behavior. To obtain more precise results on adhesion properties, pull-off adhesion test was performed. The TEOS modification of the epoxides resulted in increases in the pull-off adhesion from 50% at 2.5 wt % TEOS to >100% at 10 wt % TEOS. The flexibility of the films was judged by the reverse impact test and showed that flexibility was not dependent on the TEOS loading (except for the unmodified epoxide, EO).

TABLE 6
Coating properties of the epoxy hybrid coatings

| | | | Reverse | |
|---|---|---|---|---|
| | | | Impact* | Pull-off |
| Hybrid | Pencil | Crosshatch | Resistance | Adhesion^{‡} |
| Networks | Hardness | Adhesion | (lb_{f}/in) | (lb_{f}/in²) |
| E0^{a} | 4H | 4B | 22 ± 3 | 110 ± 10 |
| E2.5 | 5H | 5B | 20 ± 2 | 163 ± 15 |
| E5 | 5H | 5B | 15 ± 2 | 185 ± 5 |
| E7.5 | 5H | 5B | 20 ± 3 | 242 ± 13 |
| E10 | 5H | 5B | 15 ± 3 | 248 ± 8 |
| EE0 | 5H | 5B | >40 | 128 ± 7 |
| EE2.5^{b} | 5H | 5B | >40 | 188 ± 11 |
| EE5 | 5H | 5B | >40 | 242 ± 8 |
| EE7.5 | 5H | 5B | >40 | 285 ± 15 |
| EE10 | 5H | 5B | >40 | 293 ± 10 |
| EP0 | 5H | 5B | >40 | 120 ± 10 |
| EP2.5 | 5H | 5B | >40 | 192 ± 8 |
| EP5^{c} | 5H | 5B | >40 | 250 ± 10 |
| EP7.5 | 5H | 5B | >40 | 305 ± 5 |
| EP10 | 5H | 5B | >40 | 313 ± 12 |

^{a}E0 denotes the film formed through the epoxy resin with 0% TEOS oligomer based on the amount of the total solution.
^{b}EE2.5 denotes the film formed through the epoxy ester with 2.5% TEOS oligomer based on the amount of the total solution.
^{c}EPS denotes the film formed through the epoxy phosphate with 5% TEOS oligomer based on the amount of the total solution.
*Average of three reverse impact resistance values were reported for each system in lb_{f}/in.
^{‡}Average values of bond strengths obtained from three dollies were reported in lb_{f}/in². The error is at most ±15 bond strength units.

Corrosion performance of the films are shown in FIGS. 10, 11 and 12. FIG. 10 shows the images of the epoxy hybrid primers coated on untreated steel substrate after 96 h and 264 h salt spray exposure. No blistering or lifting of the coat was observed for any of the 24 h salt spray exposed panels. However, corrosion was observed on unmodified epoxy derivatives after 48 h exposure. The panels coated with inorganic modified epoxides (E5, E7.5 and E10) passed the salt spray test even after 264 h exposure.

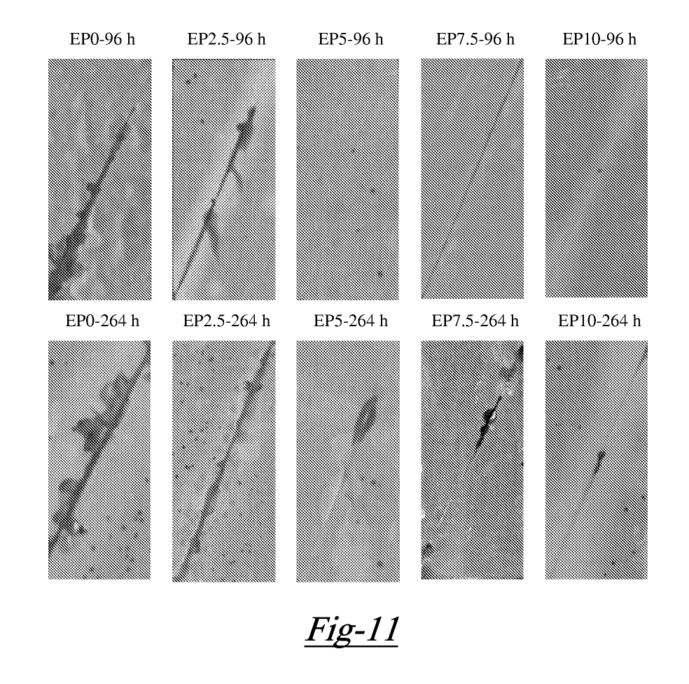

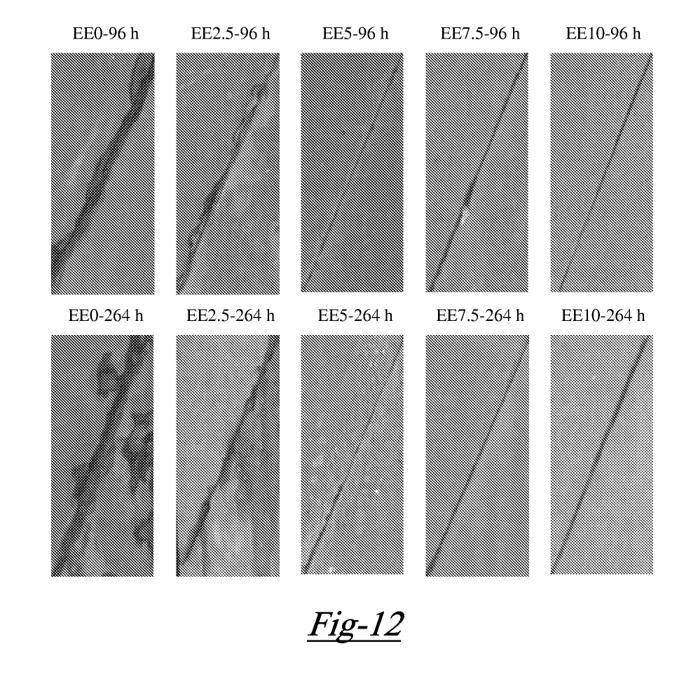

The salt spray test results of the epoxy phosphate and epoxy ester hybrid primers are demonstrated in FIGS. 11 and 12 respectively. The scribed panels were evaluated up to 264 h of exposure to salt spray. The inspections were made periodically, although only the images for 96 and 264 h were shown in FIGS. 10, 11 and 12. Buchheit et al. [53] used an inspection method in an attempt to quantify corrosion damage via pitting occurred during salt spray exposure. In their study, panels were assigned a pass or fail rank at each inspection interval. Based on their criterion, the changes in pitting damage versus time were evaluated for the panels. For example, the blistering in EP0 diminishes dramatically with increasing the inorganic content in the system, producing no visible corrosion product stain or tail for EP10 after 96 h exposure (See FIG. 11). The coated panels of the epoxy derivatives modified with TEOS oligomer content higher than 5 wt. % passed the corrosion performance test, having no more than five isolated spots or pits, none larger than 0.031 in. (0.8 mm) in diameter. Further improvement in the salt spray performance of coated panels was observed with modifying epoxide resin with phosphoric acid and unsaturated fatty acid.

The neat epoxy ester coated sample failed only after 24 h of exposure in salt spray, while inorganic modified samples withstood more than around 200 h of exposure. The best salt spray performance was always observed when epoxy coatings were inorganically modified with 10 wt. % TEOS oligomer. The phosphated epoxy and epoxy ester were found to provide substantial improvement over epoxide resin by significantly improving the blister resistance, as well as providing improved adhesion to metal substrates (See Table 6).

It is appreciated that in the epoxy ester systems, the grafting of the fatty acid provides a capability for an autoxidative cure (thermosetting) mechanism since an unsaturated fatty acid was chosen [15]. The glass transition temperatures are very low in comparison to the epoxy and the epoxy phosphate counterparts due to the flexibility improvements. The flexibility results from the conversion of the epoxy end groups from 1,2-oxirane to ester groups. The decrease in glass transition temperature is also observed in epoxy phosphate (EP) films (See Table 5). The same approach may prevail that the 1,2-oxirane groups react with phosphoric acid and water to form phosphate esters. In addition, the unreacted low molecular weight species may also act as a plasticizer, resulting in lower glass transition temperature.

The phosphate ester group was found to increase the adhesion to metal substrates by reaction with the metal, therefore producing a strong chemical bond between the coating polymer and the metal [25,57]. This metal-phosphate bond is more resistant to displacement by water than the normal coating hydrogen bond to metal substrates, and contributed to improvements in corrosion resistance of the coatings as well (See FIG. 11). Adhesion also increased by the inclusion of the TEOS oligomers but leveled off with further increase in the concentration of the TEOS oligomers (See Table 6). This behavior was also observed by Soucek et al. [29] in the polyurea/polysiloxane ceramer system. The adhesion increase can be attributed to the increase in the number of the Si—O—H bonds formed on the surface of the steel panel. Thus, the epoxy resin modified with both phosphate ester group and TEOS oligomer is expected to obtain better adhesion on metal substrates. The reason that the TEOS oligomer modified epoxies can get better adhesion on metal substrate is because the silanol groups (Si—OH) in the modified resin can bond with the metal hydroxyls (M-OH) to form Si—O-M linkage due to the condensation reaction.

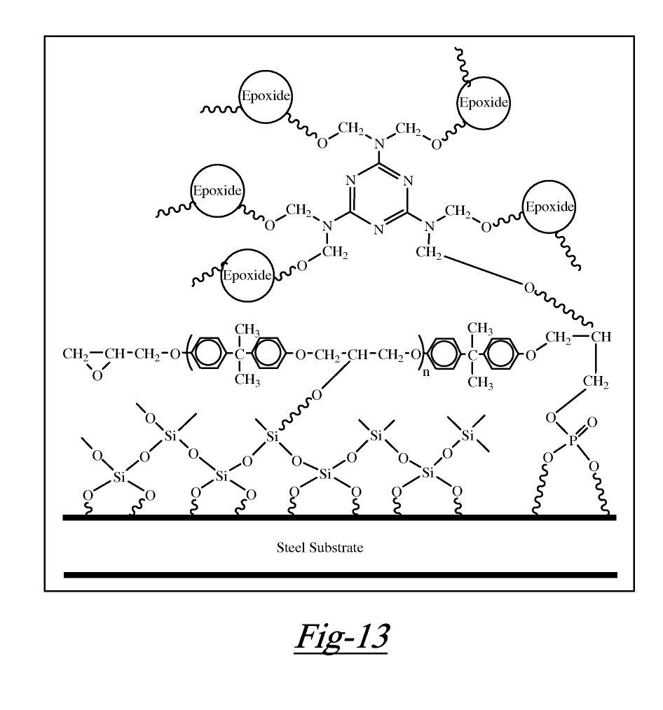

Not being bound by theory, and based in part on the images of the hybrid coatings taken after salt spray exposure (See FIGS. 10, 11, and 12), a mechanism of corrosion protection is proposed in FIG. 13. In anti-corrosion coatings, the use of epoxide resin dominates over other synthetic resins due to its improved bonding with metallic substrates and long-term corrosion resistance. However, since epoxy resin is hydrophilic in nature, the moisture resistance is compromised. The formation of well-adhered sol-gel layer on the steel substrate can block the transport of the chemical species of corrosion reaction, mainly including water and oxygen, onto the coating substrate interface, and limit the rate of corrosion.

In view of the teaching presented herein, it is to be understood that numerous modifications and variations of the present invention will be readily apparent to those of skill in the art. For example, while the invention has primarily been described with reference to bisphenol-A (BPA) based liquid epoxide resin and tetraethylorthosilicate, other epoxide resins and alkoxysilane oligomers may likewise be used in combination to provide modified epoxy derivatives with substantial improvement over epoxide resins. As such, the foregoing is illustrative of specific embodiments of the invention but is not meant to be a limitation upon the practice thereof. It is the following claims, including all equivalents, which define the scope of the invention.

### REFERENCES

[1] Novak, B. M., Advanced Materials 1993; 5(6):422.
[2] Wen, J.; Jordens, K.; Wilkes, G. L., Materials Research Society Symposium Proceedings 1996; 435:207.
[3] Alexandre, M.; Dubois, P., Materials Science and Engineering 2000; 28:1.
[4] Matejka, L.; Dukh, O.; Kolarik, J., Polymer 2000; 41:1449.
[5] Matsuura, Y.; Matsukawa, K.; Kawabata, R.; Higashi, N.; Niwa, M.; Inoue, H., Polymer 2002; 43:1549.
[6] Wirnsberger, G.; Scott, B. J.; Chmelka, B. F.; Stucky, G. D., Advanced Materials 2000; 12:1450.
[7] Yano, K.; Usuki, A.; Okada, A., Journal of Polymer Science 1997; 35:2289.
[8] Mark, J. E.; Jiang, C.; Tang, M. Y., Macromolecules 1984; 17:2613.
[9] Landry, C. J. T.; Coltrain, B. K.; Brady, B. K., Polymer 1992; 33:1486.
[10] Mark, J. E., Polymer Engineering and Science 1996; 36:2905.
[11] Gigant, K.; Posset, U.; Schottner, G., Applied Spectroscopy 2002; 56:762.
[12] Klukowska, A.; Posset, U.; Schottner, G.; Wis, M. L.; Salemi-Delvaux, C.; Malatesta, V., Materials Science 2001; 20:95.
[13] MacKenzie, J. D.; Bescher, E. P., Journal of Sol-Gel Science and Technology 1998; 13:371.
[14] Spanhel, L.; Popall, M.; Muller, G., Proceedings of the Indian Academy of Sciences: Chemical Sciences 1995; 107:637.
[15] Wicks, Z. W., Jr.; Jones, F. N.; Pappas, S. P., Organic Coatings Science and Technology, 2^{nd} ed. NY: John Wiley & Sons, 1999.
[16] Paul, S., Surface Coatings Science and Technology, 2^{nd} ed. NY: John Wiley & Sons, 1996.
[17] Lambourne, R., Ed., Paint and Surface Coatings Theory and Practice. NY: John Wiley & Sons, 1987.
[18] Soucek, M. D., Inorganic/Organic Hybrid Coatings. In: Kickelbick, G., editor. Hybrid Materials. Weinheim, German: Wiley-VCH Verlag GmbH & Co. KGaA, 2007.
[19] Judeinstein, P.; Sanchez, C. J., Materials Chemistry 1996; 6:511.
[20] Huang, H. H.; Wilkes, G. L.; Carlson, J. G., Polymer 1989; 30:2001.
[21] Wilkes, G. L.; Orler, B.; Huang, H. H., Polymer Preprints (American Chemical Society, Division of Polymer Chemistry) 1985; 26(2):300.
[22] Ahmad, Z.; Sarwar, M. I.; Mark, J. E., Journal of Materials Chemistry 1997; 7(2):259.
[23] Girard-Reydet, E.; Lam, T. M.; Pascault, J. P., Macromolecular Chemistry and Physics 1994; 195(1):149.
[24] Child, T. F.; Van Ooij, W. J., Transactions of the Institute of Metal Finishing 1999; 77(2):64.
[25] Massingill, J. L., Journal of Coatings Technology 1991; 63(797):47.
[26] Sabata, A.; Van Ooij, W. J.; Koch, R. J., Journal of Adhesion Science and Technology 1993; 7(11):1153.
[27] Witucki, G. L., Journal of Coatings Technology 1993; 65(822):57.
[28] Holmes-Farley, S. R.; Yanyo, L. C., Journal of Adhesion Science and Technology 1991; 5(2):131.
[29] Ni, H.; Simonsick, W. J.; Skaja, A. D.; Williams, J. P.; Soucek, M. D., Progress in Organic Coatings 2000; 38(2):97.
[30] Ni, H.; Skaja, A. D.; Soucek, M. D., Progress in Organic Coatings 2000; 40(1-4):175.
[31] Ni, H.; Skaja, A. D.; Sailer, R. A.; Soucek, M. D., Macromolecular Chemistry and Physics 2000; 201(6):722.
[32] Ni, H.; Skaja, A. D.; Sailer, R. A.; Soucek, M. D., Polymeric Preprints (American Chemical Society, Division of Polymer Chemistry) 1998; 39(1):367.
[33] Ni, H.; Skaja, A. D.; Sailer, R. A.; Soucek, M. D., Polymeric Materials Science and Engineering 1998; 79:21.
[34] Tuman, S. J.; Soucek, M. D., Journal of Coatings Technology 1996; 68:73.
[35] Tuman, S. J.; Chamberlain, D.; Scholsky, K. M.; Soucek, M. D., Progress in Organic Coatings 1996; 28:251.
[36] Lan, T.; Pinnavaia, T. J., Materials Research Society Symposium Proceedings 1996; 435:79.
[37] Messersmith, P. B.; Giannelis, E. P., Chemistry Materials 1994; 6:1719.
[38] Wang, M. S.; Pinnavaia, T. J., Chemistry Materials 1994; 6:468.
[39] Landry, M. R.; Coltrain, B. K.; Landry, C. J. T.; O'Reilly, J. M., Journal of Polymer Science, Part B: Polymer Physics 1995; 33(4):637.
[40] Hussain, M.; Nishijima, S.; Nakahira, A.; Okada, T.; Niihara, K., Materials Research Society Symposium Proceedings 1996; 435:369.
[41] Bauer, B. J.; Liu, D.-W.; Jackson, C. L.; Barnes, J. D., Polymers for Advanced Technologies 1996; 7(4):333.
[42] Matejka, L.; Dusek, K.; Plestil, J.; Kriz, J.; Lednicky, F., Polymer 1999; 40(1):171.
[43] Matejka, L.; Plestil, J.; Dusek, K., Journal of Non-Crystalline Solids 1998; 226(1,2):114.
[44] Ellis, B., Introduction to the Chemistry, Synthesis, Manufacture, and Characterization of Epoxy Resins In: Ellis, B., editor. Chemistry and Technology of Epoxy Resins. London, UK: Blackie Academic & Professional, an imprint of Chapman & Hall, 1993.
[45] Hill, L. W.; Kozlowski, K., Journal of Coatings Technology 1987; 59(751):63.
[46] Bienstock, D.; Field, J. H., Corrosion 1961; 17:89.
[47] Aparicio, M.; Klein, L. C., Ceramic Transactions (Sol-Gel Commercialization and Applications) 2000; 123:73.
[48] Rao, K. J.; Baskaran, N.; Ramakrishnan, P. A.; Ravi, B. G.; Karthikeyan, A., Chemistry Materials 1998; 10:3109.
[49] Silverstein, R. M.; Bassler, G. C.; Morrill, T. C., Spectrometric Identification of Organic Compounds, 4^{th} ed. NY: John Wiley & Sons, 1981.
[50] Nassar, E. J.; Nassor, E. C. D. O.; Avila, L. R.; Pereira, P. F. S.; Cestari, A.; Luz, L. M.; Ciuffi, K. J.; Calefi, P. S., Journal of Sol-Gel Science and Technology 2007; 43:21.
[51] Nielsen, L. E.; Landel, R. F., Mechanical Properties of Polymers and Composites. NY: Marcel Dekker, 1994.
[52] Pascault, J. P.; Sautereau, H.; Verdu, J.; Williams, R. J., Thermosetting Polymers. NY: Marcel Dekker, 2002.
[53] Buchheit, R. G.; Cunningham, M.; Jensen, H.; Kendig, M. W.; Martinez, M. A., Corrosion 1998; 54(1):61.
[54] Teng, G.; Soucek, M. D., Progress in Organic Coatings 2001; 1057:1.
[55] Hill, L. W., Journal of Coatings Technology 1992; 64:27.
[56] Wold, C. R.; Soucek, M. D., Macromolecular Chemistry and Physics 2000; 201:382.
[57] Massingill, J. L., Jr.; Whiteside, R. C., Journal of Coatings Technology 1993; 65(827):65.

We claim:

1. A modified epoxide primer composition comprising:
a telechelic resin having reactive end groups; and
an alkoxide oligomer.

2. The composition of claim 1, wherein the telechelic resin is an epoxide having reactive end groups.

3. The composition of claim 2, wherein the epoxide has at least two phenol functional groups.

4. The composition of claim 3, wherein the epoxide is bisphenol-A (BPA) epoxide.

5. The composition of claim 3, wherein the epoxide is a cycloaliphatic epoxide.

6. The composition of claim 1, wherein the reactive end groups have at least one hydroxide group.

7. The composition of claim 1, wherein the telechelic resin having reactive end groups is an epoxy phosphate.

8. The composition of claim 1, wherein the telechelic resin having reactive end groups is an epoxy ester.

9. The composition of claim 1, wherein the telechelic resin having reactive end groups is an epoxy molybdate.

10. The composition of claim 1, wherein the alkoxide oligomer is a metal alkoxide oligomer.

11. The composition of claim 1, wherein the alkoxide oligomer is an alkoxysilane oligomer.

12. The composition of claim 11, wherein the alkoxysilane oligomer is a tetraethylorthosilicate oligomer.

13. The composition of claim 11, wherein the alkoxysilane oligomer is a tetramethylorthosilicate oligomer.

14. A process for making a modified epoxide primer comprising:
providing a telechelic resin with reactive end groups; and
contacting the telechelic resin with reactive end groups with an alkoxide oligomer.

15. The process of claim 14, wherein the telechelic resin with reactive end groups includes an epoxide with reactive end groups.

16. The process of claim 15, wherein the epoxide includes at least two phenol functional groups.

17. The process of claim 15, wherein the epoxide includes a bisphenol-A (BPA) epoxide.

18. The process of claim 15, wherein the epoxide includes a cycloaliphatic epoxide.

18. The process of claim 14, wherein the telechelic resin having reactive end groups is an epoxy phosphate.

19. The process of claim 14, wherein the telechelic resin having reactive end groups is an epoxy ester.

20. The process of claim 14, wherein the alkoxide oligomer is an alkoxysilane oligomer.
